(19) United States
(12) Patent Application Publication
(10) Pub. No.: US 2010/0037872 A1
(43) Pub. Date: Feb. 18, 2010

(54) PREVENTING EGR SYSTEM SOOT CONTAMINATION

(75) Inventor: Marek Kowalczyk, Westland, MI (US)

Correspondence Address: Harness Dickey & Pierce, P.L.C., P.O. Box 828, Bloomfield Hills, MI, 48303, US

(73) Assignee: GM GLOBAL TECHNOLOGY OPERATING, INC., DETROIT, MI (US)

(21) Appl. No.: 12/193,241

(22) Filed: Aug. 18, 2008

(51) Int. Cl. F02M 25/07

(52) U.S. Cl. 123/568.12

(57) ABSTRACT

A diesel engine system is provided with an exhaust passage having a diesel particulate filter disposed in the passage. An exhaust gas recirculation passage is connected to the exhaust passage at a downstream location of the diesel particulate filter and in communication with the air intake passage. By locating the connection to the exhaust passage at a location downstream from the diesel particulate filter, the exhaust gas recirculation passage and the exhaust gas recirculation cooler disposed therein are isolated from soot contamination.

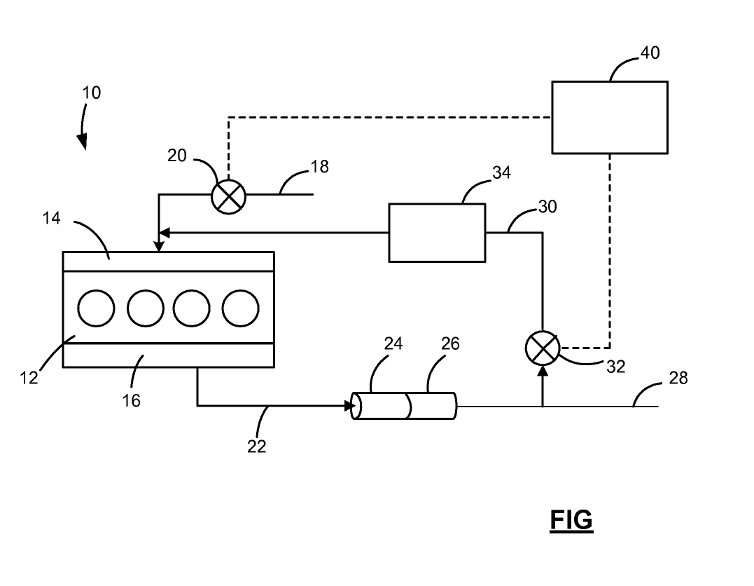

### FIELD

The present disclosure relates to a diesel engine system, and more particularly, to a diesel engine system including an exhaust gas recirculation (EGR) passage connected to an exhaust gas passage downstream of a diesel particulate filter in order to prevent soot contamination of the exhaust gas recirculation passage cooler.

### BACKGROUND AND SUMMARY

The statements in this section merely provide background information related to the present disclosure and may not constitute prior art.

Previously, exhaust gas recirculation feed tubes have come off the exhaust pipe upstream of the diesel particulate filter. On diesel engines, there is a lot of soot in the exhaust passage at this location. The soot tends to collect on the walls of the exhaust gas recirculation cooler due to lower temperatures and the small tube diameter of the EGR cooler.

The present disclosure provides the connection of the exhaust gas recirculation passage downstream of the diesel particulate filter in order to prevent soot contamination of the EGR cooler.

Further areas of applicability will become apparent from the description provided herein. It should be understood that the description and specific examples are intended for purposes of illustration only and are not intended to limit the scope of the present disclosure.

### DRAWINGS

The drawing described herein is for illustration purposes only and is not intended to limit the scope of the present disclosure in any way.

The FIGURE is a schematic diagram of a diesel engine system having an exhaust gas recirculation passage connected downstream of the diesel particulate filter in order to prevent soot contamination of the exhaust gas recirculation cooler.

### DETAILED DESCRIPTION

The following description is merely exemplary in nature and is not intended to limit the present disclosure, application, or uses.

With reference to the FIGURE, the engine system 10, according to the principles of the present disclosure, will now be described. The engine system 10 includes a diesel engine 12 having an intake manifold 14 and an exhaust manifold 16. The intake manifold 14 is connected to an intake passage 18 that can include an intake throttle valve 20 disposed therein for controlling the passage of intake air to the engine 12.

The exhaust manifold 16 is connected to an exhaust passage 22 provided with a diesel oxidation catalyst (DOC) and NOₓ device 24 for removing nitric oxide (NO) and nitrogen oxide (NO₂) and a diesel particulate filter (DPF) 26 provided upstream from a tailpipe 28. The diesel oxidation catalyst and NOₓ device each remove harmful exhaust constituents in a manner well known in the art and can be any known device currently used in the art.

An exhaust gas recirculation passage 30 is provided in communication with the exhaust passage 22 at a downstream location from the diesel particulate filter 26 and in communication with the intake passage 18. The exhaust gas recirculation passage 30 is provided with an exhaust gas recirculation valve 32 which is selectively controlled to control the amount of exhaust gas recirculated to the intake passage 18. The exhaust gas recirculation valve 32 can be controlled in accordance with previously known control parameters for introducing exhaust gas into the intake passage. An exhaust gas recirculation cooler 34 can also be provided in the exhaust gas recirculation passage 30 for cooling the exhaust gas to a desired temperature prior to introduction into the intake passage 18.

An engine controller 40 is provided for controlling operation of the intake throttle 20 and exhaust gas recirculation valve 32 to provide a proper mix of fresh air and recirculated exhaust gas. The engine controller 40 can also control many other functions of the engine responsive to driver inputs and other driving conditions, as is known in the art.

Connecting the exhaust gas recirculation passage 30 to the exhaust passage 22 downstream from the diesel particulate filter 26 prevents the exhaust gas recirculation cooler 34 from becoming clogged due to high soot contamination. This results in improved durability of the exhaust gas recirculation system on diesel engine systems.

What is claimed is:

1. An engine system, comprising:
a diesel engine;
an exhaust passage connected to the diesel engine;
a diesel particulate filter disposed in the exhaust passage;
an air intake passage for supplying air to the diesel engine; and
an exhaust gas recirculation passage connected to the exhaust passage downstream of the diesel particulate filter and in communication with the air intake passage.

2. The engine system according to claim 1, further comprising an exhaust gas recirculation cooler in the exhaust gas recirculation passage.

3. The engine system according to claim 1, further comprising an exhaust gas recirculation valve in the exhaust gas recirculation passage.

4. The engine system according to claim 3, further comprising an engine controller for controlling operation of the exhaust gas recirculation valve.

5. An exhaust gas recirculation system for a diesel engine, comprising:
an exhaust passage connected to the diesel engine;
a diesel particulate filter disposed in the exhaust passage;
an exhaust gas recirculation passage connected to the exhaust passage downstream of the diesel particulate filter and in communication with an air intake passage of the diesel engine.

6. The exhaust gas recirculation system according to claim 5, further comprising an exhaust gas recirculation cooler in the exhaust gas recirculation passage.

7. The exhaust gas recirculation system according to claim 5, further comprising an exhaust gas recirculation valve in the exhaust gas recirculation passage.

8. The exhaust recirculation system according to claim 7, further comprising an engine controller for controlling operation of the exhaust gas recirculation valve.
